(19) United States
(12) Patent Application Publication
(10) Pub. No.: US 2013/0068032 A1
(43) Pub. Date: Mar. 21, 2013

(54) MECHANICAL STRESS DETECTOR

(71) Applicant: Jean-Pierre Nikolovski, Chatenay-Malabry (FR)

(72) Inventor: Jean-Pierre Nikolovski, Chatenay-Malabry (FR)

(73) Assignee: Commissariat a l'energie atomique et aux energies alternatives, Paris (FR)

(21) Appl. No.: 13/580,276

(22) PCT Filed: Mar. 14, 2011
(86) PCT No.: PCT/FR11/50507

§ 371 Date: Aug. 21, 2012

(30) Foreign Application Priority Data
Mar. 17, 2010 (FR) 1051891

(51) Int. Cl. G01L 1/16

(52) U.S. Cl. CPC G01L 1/162
USPC 73/778

(57) ABSTRACT

A detector including: a control device configured to provide an electrical control signal in response to a mechanical stress; an emission transducer configured to convert the electrical control signal into a detection signal; a supply piezoelectric element connected electrically to the control device and configured to provide, when mechanically excited, an electrical supply energy to the control device; and a device for mechanically exciting the supply piezoelectric element using the mechanical stress.

This invention relates to a mechanical stress detector.

The invention applies more particularly in the field of home automation. Indeed, home automation often requires a communication between the persons and the intelligent devices arranged in the home. This communication can in particular be expressed in the form of a mechanical stress exerted by the user on a mechanical stress detector, either directly—for example, the user presses on a button or walks on it, or indirectly—for example, the user opens a door which itself stresses the detector.

Japanese patent application published under number JP 2000 079839 describes a mechanical stress detector comprising a control device designed to provide an electrical control signal in response to a mechanical stress, and a transducer, called an emission transducer, designed to convert the electrical control signal into a detection signal.

More precisely, in this document, the mechanical stress is detected by an acceleration sensor, recorded by means of recording and transmitted to a processing device by means of a wireless transducer.

Such a detector comprises its own source of energy in order to be able to function in a fully wireless manner. This source of energy generally takes the form of a battery, and sometimes the form of solar or wind energy collector. In any case, known detectors have the disadvantage of being bulky.

It can also be sought to provide a mechanical stress detector which makes it possible to overcome at least part of the aforementioned problems and constraints.

An object of the invention is therefore a mechanical stress detector comprising a control device designed to provide an electrical control signal in response to a mechanical stress, and a transducer, called an emission transducer, designed to convert the electrical control signal into a detection signal, this detector further comprising a piezoelectric element, called a supply piezoelectric element, connected electrically to the control device and designed to provide, when mechanically excited, an electrical supply energy to the control device, and a device for mechanically exciting the supply piezoelectric element using the mechanical stress.

Thus, thanks to the invention, there is no longer any need to use a battery or a solar or wind energy collector which makes it possible to obtain a self-powered detector of reduced size.

Optionally, the mechanical excitation device comprises a flexible element designed to sag in response to the mechanical stress, and, over a first range of sagging from an idle position, called an initial idle position, to store up the potential energy, the first range of sagging comprising a drop in the variation rate of the stored up potential energy.

Also optionally, the flexible element is designed to, over a second range of sagging subsequent to the first range of sagging, restore the stored up potential energy.

Also optionally, the mechanical excitation device further comprises a resonating element arranged in order to be struck by the flexible element during its displacement, and the supply piezoelectric element is fixed to the resonating element.

Also optionally, the resonating element is a resonating disc arranged to be struck by the flexible element at its centre, and the supply piezoelectric element is a piezoelectric ring, called a supply piezoelectric ring, fixed along the periphery of a surface of the resonating disc.

Also optionally, the detector further comprises a device for storing the electrical supply energy supplied by the supply piezoelectric element, the control device being supplied by the electrical supply energy stored in the storage device.

Also optionally, the control device comprises an electrical signal source and a modulation device of the electrical signal of the source in order to generate the electrical control signal.

Also optionally, the detector further comprises a piezoelectric element, called a source piezoelectric element, arranged in order to supply an electrical energy, called a source electrical energy, when excited, and the mechanical excitation device is designed to excite furthermore the source piezoelectric element, and the electrical signal source comprises a device for storing the source electrical energy supplied by the source piezoelectric element.

Also optionally, the source piezoelectric element is a piezoelectric ring, called a source piezoelectric ring, fixed along the periphery of a surface of the resonating disc.

Also optionally, the modulation device comprises a processing unit, supplied by the supply energy supplied by the supply piezoelectric element, designed to supply a digital control signal, and a switching device, controlled by the digital control signal, in order to connect the emission transducer selectively to the electrical signal source and to an electrical earth.

Also optionally, the emission transducer comprises a piezoelectric element, called an emission piezoelectric element, to which is applied the control signal in order to supply the detection signal in the form of a seismic wave.

Also optionally, the emission piezoelectric element is fixed on the resonating element.

Also optionally, the emission piezoelectric element is the source piezoelectric element.

The invention shall be better understood using the following description, provided solely by way of example and in reference to the annexed drawings wherein:

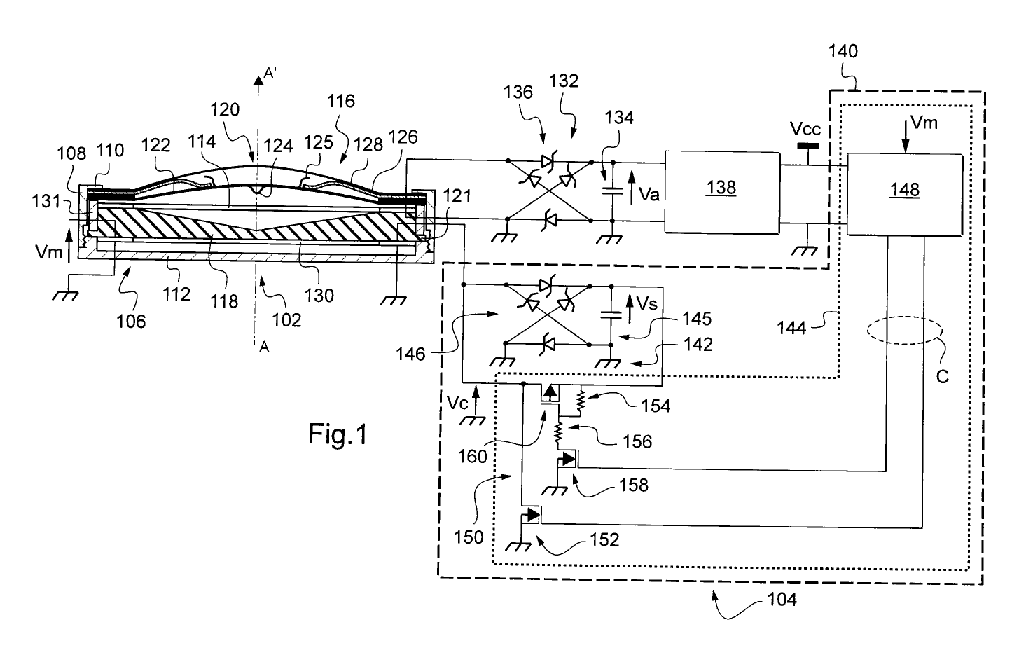

FIG. 1 is a diagrammatical representation of a mechanical stress detector, according to an embodiment of the invention,

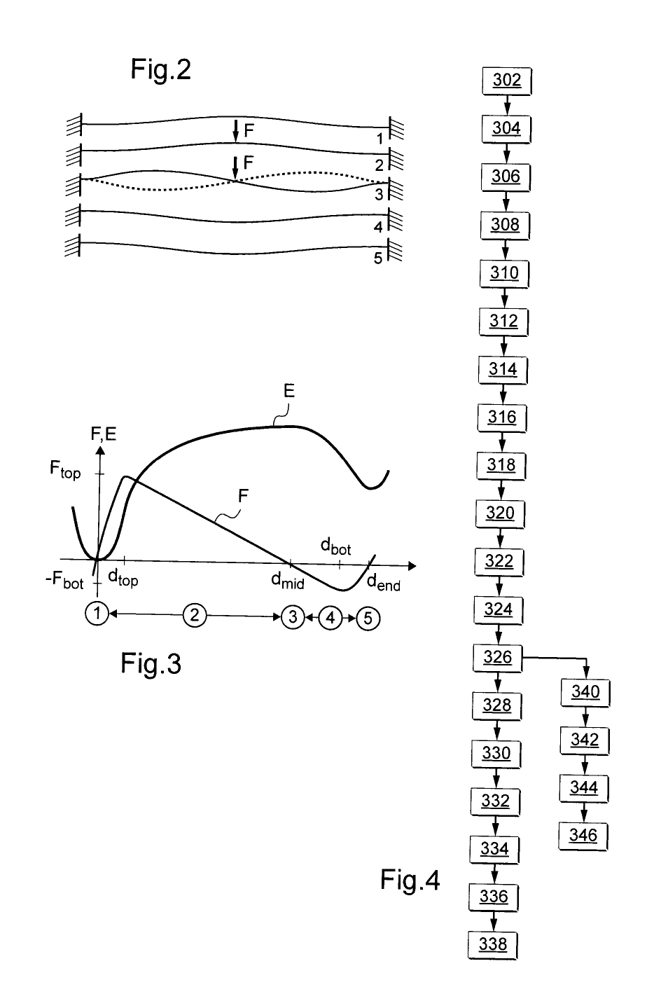

FIG. 2 is a series of cross-section views of a membrane of the detector of FIG. 1 during its deformation under the action of the mechanical stress,

FIG. 3 is a curve showing the change, according to the displacement of the membrane of FIG. 2, of the force of mechanical stress and of the stored up potential energy by the percussion membrane, and

FIG. 4 is a block diagram showing the successive steps of a method of generating a detection signal, implemented by the detector of FIG. 1.

In reference to FIG. 1, a mechanical stress detector 100 according to an embodiment of the invention comprises an actuator 102, intended to receive a mechanical stress and to emit a detection signal in the form of a seismic wave in a support (not shown), and an electronic processing circuit 104 intended to supply a control signal for the actuator 102, in the form of a control voltage Vc.

The actuator 102 comprises a case 106 of general circular cylindrical shape around a central axis AA′, this axis AA′ defining a low/high direction. The case 106 comprises a lateral portion 108 which is cylindrical circular and has an upper circular opening delimited by an edge 110 extending towards the centre of the case 106 and a bottom portion 112 closing the lateral portion 108.

The actuator 102 further comprises, arranged in the case 106, a piezoelectric element, called a supply piezoelectric element 114, designed to provide an electrical energy, called an electrical supply energy, when mechanically excited, and a mechanical excitation device 116 of the supply piezoelectric element 114 using the mechanical stress applied on the actuator 102.

The excitation device 116 comprises a resonating element 118 to which the supply piezoelectric element 114 is fixed, and a percussion mechanism 120 designed to receive the mechanical stress and strike as a response to the resonating element 118.

The resonating element 118 is a resonating disc of axis AA′ which has a thickness that is thinner at its centre than at its periphery. In the example described, this thickness decreases from the periphery towards the centre. The resonating disc 118 comprises a collar 121 resting on the bottom portion 112 of the case 106. Note that the resonating disc 118 is not in contact with the case 106 by its upper and lower surfaces, thus allowing for its deformation according to the axis AA′.

The supply piezoelectric element 114 is a piezoelectric ring, called a supply piezoelectric ring, fixed along the periphery of an upper surface of the resonating disc 118. The supply piezoelectric ring 114 comprises two electrodes, respectively on its upper and lower surfaces. One of the two electrodes, in the described example the one on its lower surface, is connected to an electrical earth. In the rest of the description, we shall speak simply of a connection with the supply piezoelectric ring 114 in order to mean a connection with its electrode not connected to the electrical earth. The supply piezoelectric ring 114 has an intrinsic capacity of 10 to 50 nanofarads.

The percussion mechanism 120 comprises a flexible element 122 designed to sag in response to the mechanical stress applied to the actuator 102. The flexible element 122 is a flexible membrane (or shell), called a percussion membrane, which is circular and extends in the upper opening of the case 106, above the resonating element 118, and the periphery of which extends under the edge 110 of the case 106. The percussion membrane 122 is designed to sag in such a way that its central portion is displaced downwards towards the resonating element 118. More preferably, the percussion membrane 122 is designed to sag in a bistable manner, such as shall be explained in more detail in reference to FIGS. 2 and 3. The bistable function of the percussion membrane 122 is for example obtained by buckling of the membrane by means of lateral mechanical constraints, or more preferably by stamping of the membrane according to a predefined profile. For a circular membrane of diameter L, the profile z according to the radius follows for example the formula:

$$z ( r ) = \frac{{d}_{end}}{2} \times ( 1 - cos ( 2 \times π \times \frac{r}{L} ) )$$

The percussion membrane 122 comprises, at its centre, a tip, called a percussion tip 124, directed downwards and intended to strike, during the sagging of the percussion membrane 122, the resonating element 118 at its centre.

The percussion membrane 122 further comprises at least one hook 125 extending towards the top.

The percussion mechanism 120 further comprises another flexible membrane (or shell), called a protective membrane 126, which is also circular and extends in the upper opening of the case 106, covering the percussion membrane 122, and the periphery of which extends under the edge 110 of the case 106. More preferably, this periphery is fixed in a sealed manner to the edge 110 of the case 106. The protective membrane 126 is intended to receive the mechanical stress and designed to sag in response, in such a way that its central portion is displaced downwards. The protective membrane 126 is furthermore designed to transmit the mechanical stress to the percussion membrane 122, by driving the latter during its sagging. The protective membrane 126 is designed to sag in a monostable or bistable manner.

The percussion mechanism 120 further comprises, for each hook 125, one or several elastic retaining tabs 128, placed between the two membranes 122, 126. They are for example each formed of a metal strip or of a wire arranged in a loop. They have one end fixed to the case 106 and a free end located above the central portion of the percussion membrane 122, and intended to cooperate with the associated hook 125 in order to exert a retaining force on the percussion membrane 122.

The actuator 102 further comprises another piezoelectric element 130 which, in the example described is a piezoelectric ring fixed along the periphery of the lower surface of the resonating disc 118. Thus, the excitation device 116 is also designed to excite this piezoelectric ring 130 in response to the mechanical stress on the actuator 102. As shall be explained in more detail in what follows, this piezoelectric ring 130 has two main functions: on the one hand, when excited by the excitation device 116, to supply the electrical energy to an electrical signal source used to generate the control signal Vc, and, on the other hand, to receive this control signal Vc in order to excite the resonating disc 118, so that the actuator 102 emits the detection signal in the form of a seismic wave. For this reason, the piezoelectric ring 130 shall be referred to in what follows as source/emission piezoelectric ring 130.

The source/emission piezoelectric ring 130 comprises two electrodes (not visible), respectively on its upper and lower surfaces. One of the two electrodes, in the described example the one on its lower surface, is connected to an electrical earth. In the rest of the description, we shall speak simply of a connection with the source/emission piezoelectric ring 130 in order to mean a connection with its electrode not connected to the electrical earth. Moreover, the source/emission piezoelectric ring 130 further comprises a third electrode (not visible) on its upper surface, of a surface much smaller than that of the other electrode of its upper surface, generally of a surface 10 to 100 times smaller. This third electrode provides a voltage Vm. The supply piezoelectric ring 114 has an intrinsic capacity of 10 to 50 nanofarads.

The actuator 102 further comprises a tightening ring 131 inserted between the percussion membrane 122 and the collar 121 of the resonating disc 118.

The edges 110 and the bottom portion 112 of the case 106 tighten between them the membranes 122, 126, the retaining tabs 128, the tightening ring 131 and the collar, in such a way as to fasten all of these elements. In particular, the collar 121 of the resonating disc 118 is thus thrust against the bottom portion 112 of the case 106 in such a way as to provide for a coupling between the resonating disc 118 and the case 106 allowing for the transmission of seismic waves between these two elements.

The electronic processing circuit 104 first comprises a storage device 132 of the electrical supply energy supplied by the piezoelectric ring 114. In the example described, the storage device 132 comprises a storage capacitor 134 and a diode bridge 136 (also called a Graetz bridge) connecting the supply piezoelectric ring 114 to the storage capacitor 134. The diode bridge 136 has for function to allow a transfer of charges only from the supply piezoelectric ring 114 to the storage capacitor 134, not in the other direction, in order to avoid discharging the latter in the supply piezoelectric ring 114. The storage capacitor 134 has a capacity 10 to 100 times higher than that of the piezoelectric elements 114, 130, approximately 1 microfarad in the example described.

The electronic processing circuit 104 further comprises a regulation device 138 of the electrical supply energy stored in the storage device 130, designed to provide a regulated electrical supply energy in the form of a constant voltage Vcc.

The electronic processing circuit 104 further comprises a control device 140, supplied by the regulated electrical supply energy Vcc, designed to generate the electrical control signal Vc.

The control device 140 comprises an electrical signal source 142 and a modulation device 144 of the electrical signal of the source 142 in order to generate the electrical control signal Vc.

In the example described, the source 142 is a storage device similar to the storage device 132, except that it is designed to store the energy supplied by the source/emission piezoelectric ring 130. The source 142 thus comprises a storage capacitor 145 and a diode bridge 146 connecting the source/emission piezoelectric ring 130 to the storage capacitor 145. The storage capacitor 145 thus provides, at its terminals, the electrical signal of the source 142 in the form of a source voltage Vs. The storage capacitor 145 has a capacity 10 to 100 times higher than that of the piezoelectric elements 114, 130, approximately 1 microfarad in the example described.

The modulation device 144 first comprises a processing unit 148 designed to supply a digital control signal C, over two bits in the example described. In this latter case, the processing unit 148 comprises two digital outputs, called digital control outputs, supplying the two bits of the digital control signal C. The processing unit 148 is supplied by the supply energy Vcc supplied by the regulation device 138. The processing unit 148 is for example a microcontroller. More preferably, this microcontroller has a real-time clock, timers, an arithmetic and logic unit, rewritable semiconductor random access and mass memories, generally called a “flash” memory, whereon is recorded a computer programme of the firmware type.

The modulation device 144 further comprises a switching device 150, controlled by the digital control signal C, in order to connect the source/emission piezoelectric ring 130 selectively to the electrical signal source 142 and to the electrical earth.

In the example described, the switching device 150 comprises a first metal oxide semiconductor field effect transistor or N-channel MOSFET, called a short-circuit transistor 152, the source of which is connected to the electrical earth, the drain of which is connected to the source/emission piezoelectric ring 130 and the gate of which is connected to one of the two digital control outputs in order to control the opening or the closing of the short-circuit transistor 152.

The switching device 150 further comprises two resistors 154, 156 mounted in series and connected on one side to the storage capacitor 145.

The switching device 150 further comprises another N-channel MOSFET transistor, called a main excitation transistor 158, the source of which is connected to the earth, the drain of which is connected to the other side of the resistors in series 154, 156 and the gate of which is connected to the other digital control output in order to control its opening or its closing.

The switching device 150 further comprises another P-channel MOSFET transistor, called an auxiliary excitation transistor 160, the source of which is connected to the storage capacitor 145, the drain of which is connected to the source/emission piezoelectric disc 130 and the gate of which is connected between the two resistors in series 154, 156. The auxiliary excitation transistor 160 is designed to turn on when the main excitation transistor 158 is turned on. The resistors 154, 156 are selected to limit the gate-source voltage of the auxiliary excitation transistor 160 when the main excitation transistor 158 is turned on.

In the absence of control signal C, the short-circuit 152 and main excitation 158 transistors are blocked (not turned on).

The operation of the bistability of the percussion membrane 122 shall now be explained.

In reference to FIG. 2, the percussion membrane 122, when it is not undergoing any mechanical stress exterior to the actuator 102, is in an idle position called an initial idle position and numbered “1” in the figure, wherein it is in stable equilibrium.

When a mechanical stress is applied to it, in the form of a force F that is exerted in its central portion downwards, the percussion membrane 122 is deformed according to a deformation mode imposed by the laws of elasticity of the material used, and is in a first intermediate position of imbalance, numbered “2” in the figure. If the force were to be withdrawn at this moment, the percussion membrane 122 would itself return to the initial idle position “1”.

By maintaining this force, the percussion membrane 122 switches to an intermediary unstable equilibrium position, called a switching position and numbered “3” in the figure, then to a second intermediate position of imbalance, numbered “4” in the figure. Finally, if there were no retaining tabs 128 and the resonating disc 118, the percussion membrane 122 would reach a “driven” position of stable equilibrium, called a final idle position and numbered “5” in the figure.

In terms of potential energy, the application of the force F on the percussion membrane 122, initially in idle position i.e. in a first well of potential energy, generates the lateral constraints in such a way that the percussion membrane 122 stores the potential energy of sagging until the switching position corresponding to a local maximum of potential energy, then switches and falls back in a second well of potential energy corresponding to the driven position.

If the percussion membrane 122 is with asymmetrical bistability, noting d as the normal displacement measured at its centre and F as the intensity of a normal force applied at its centre, the travel-force and travel-energy curves shown in FIG. 3 are obtained.

In FIG. 3, the position d=0 associated with a zero force F corresponds to the initial idle position “1” of FIG. 2. The potential energy E here is a local minimum.

On a first range of deformation 0<d<d_{mid} from the initial idle position “1”, the force F to be supplied is positive (i.e. directed downwards), in such a way that the percussion membrane 122 stores up the potential energy. On this first range, the percussion membrane 122 is in the position “2” of FIG. 2. For example, when the percussion membrane 122 is made of brass, has a thickness of 0.45 millimetres and a diameter of 30 millimetres, and when it is pressed onto a half travel d_{mid}/2 equal to 0.5 millimetres, it is able to store a potential energy between 5 and 10 millijoules.

More precisely, on a first sub-range of deformation 0<d<dₜₒₚ, the force F to be supplied is increasing, in such a way that the percussion membrane 122 stores the potential energy with a first positive variation rate (the value of the force to be supplied increases with a certain slope or variation rate when d increases). On a second sub-range of deformation dₜₒₚ≦d≦d_{mid}, the force F to be supplied is still positive but decreasing, in such a way that its slope or variation rate is lower and that the percussion membrane 122 stores the potential energy with a second variation rate (the value of the force to be supplied) which decreases.

So, the first range of deformation 0<d<d_{mid} comprises a drop in the variation rate of the stored up potential energy. This drop makes it possible to obtain a ripple effect: generally, the force actually applied does not decrease as fast as the force to be supplied, in such a way that more energy than is necessary is supplied to the displacement d of the percussion membrane 122. The surplus energy is then stored up by this percussion membrane 122 in the form of kinetic energy. The position d=dₜₒₚ, reached at the end of the first sub-range, associated with a positive intensity threshold force Fₜₒₚ corresponds to the start of the ripple effect.

The position d=d_{mid} corresponds to a zero force located between the two stable positions. It corresponds to the instable equilibrium position “3” of FIG. 2.

After this instable equilibrium position, the force F to be supplied is negative (i.e. directed upwards) on a second range of deformation d_{mid}<d<d_{end}, in such a way that the percussion membrane 122 restores the stored up potential energy. On this second range, the percussion membrane 122 is in the position “4” of FIG. 2. So, the ripple effect is amplified as it is self-maintained by the percussion membrane 122 itself.

The position d=d_{end} associated with a zero force F to be supplied corresponds to the second stable position “5” of the bistable zone.

The asymmetry of the bistability of the percussion membrane 122 is linked to the difference in intensity between Ftop and Fbot.

It is more advantageous to use a bistable than a monostable in order to obtain a pulse vibration because, during its driving, the central region of the bistable takes more speed during its travel between dₜₒₚ and d_{end}, by the ripple effect and restitution of energy, until it is suddenly blocked by the percussion with the resonating disc 118.

In reference to FIG. 4, a method 300 for detecting mechanical stress implemented by the detector of FIG. 1 includes the following steps.

During a step 302, a mechanical stress in the form of a vertical force directed downwards is applied to the centre of the protective membrane 126, which is in an initial idle position.

During a step 304, under the effect of the mechanical stress, the protective membrane 126 sags and its central portion is displaced downwards.

During a step 306, the protective membrane 126 comes into contact with the retaining tabs 128 and transmits the mechanical stress to them.

During a step 308, the retaining tabs 128 come into contact with the percussion membrane 122, in such a way that the protective membrane 126 transmits the mechanical stress to the percussion membrane 122 by the intermediary of retaining tabs 128. The two membranes 122, 126 and the retaining tabs 128 are then displaced together downwards. In particular, the percussion membrane 122 is deformed and its central portion is displaced downwards, in such a way that it is in the imbalance position “2” in FIG. 2.

During a step 310, the percussion membrane 122 exceeds the instable equilibrium position “3” of FIG. 2 and therefore restores the stored up potential energy in such a way that it tends to be displaced itself towards the final idle position “5” in FIG. 2.

During a step 312, the percussion tip 124 strikes the resonating disc 118 at its centre. The percussion tip 124 remains in contact with the resonating disc 118 as long as the mechanical stress is maintained.

During a step 314, in response to the percussion, the resonating disc 118 enters into resonance and excites the two piezoelectric rings 114, 130. The resonance is constrained due to the pressure, resulting from the mechanical stress, exerted by the percussion tip 124 on the resonating disc 118.

During a step 316, in response to their excitation, the two piezoelectric rings 114, 130 provide respectively the supply energy to the first storage device 132 and the source energy to the second storage device, i.e. the source 142. Moreover, the source/emission piezoelectric ring 130 provides the voltage Vm which expresses the constraint of the percussion tip 124 on the resonating disc 118, and therefore the intensity of the mechanical stress.

During a step 318, the storage capacitors 134, 145 are charged and have at their terminals respectively the supply voltage Va and the source voltage Vs.

During a step 320, the regulation device 138 receives the electrical energy stored in the storage capacitor 134 and provides, using this electrical energy withdrawn, a regulated energy in the form of voltage Vcc.

During a step 322, the processing unit 148 receives the regulated electrical energy by being under voltage by the constant voltage Vcc.

During a step 324, the processing unit 148 is initialized and starts the execution of its firmware.

During a step 326, the processing unit 148 executing its firmware reads the voltage Vm and from it deduces the intensity of the mechanical stress.

During a step 328, the processing unit executing its firmware generates a digital control signal C on its two digital outputs. The digital control signal C comprises more preferably an identification number of the detector and information on the intensity of the mechanical stress.

During a step 330, the digital control signal C causes the activation and the deactivation of the transistors 152 and 156, in order to successively connect the source/emission piezoelectric ring 130 to the signal source 142 and to the electrical earth. This succession of connections and disconnections produces an analogue control signal in the form of the control voltage Vc applied to the source/emission piezoelectric ring 130. This control voltage successively takes the value zero corresponding to the connection with the electrical earth, and a high value corresponding to the voltage Vs at the terminals of the storage capacity 145.

During a step 332, the source/emission piezoelectric ring 130 is deformed under the action of the control voltage Vc and excites the resonating disc 118.

During a step 334, the excited resonating disc 118 enters into resonance and as such generates a detection signal in the form of a seismic wave comprising a series of pulses at the resonating frequency of the resonating disc 118, these pulses corresponding to the high values (Vs) of the control voltage C. The resonating disc 118 transmits the sound wave at a characteristic frequency that can be chosen between 1 kHz and 10 kHz according to the diameter of the resonating disc 118 and its thickness.

The pulses generated thus comprise, i.e. encode, the identification number of the detector 100 as well as the intensity of the mechanical stress.

Note that the source/emission piezoelectric ring 130 and the resonating disc 118 together form a transducer supplying the detection signal, in the form of a seismic wave, using the control signal Vc.

During a step 336, the detection signal propagates from the resonating disc 118 to the case 106 of the actuator 102, thanks to the coupling via the collar 121 of the resonating disc 118.

Finally, during a step 338, the detection signal propagates from the case 106 of the actuator 102 to the support (not shown). Thus, the detection signal can be received and decoded by a remote receiver (not shown) designed to detect the seismic waves in the support (not shown).

Moreover, during a step 340 occurring at a given moment during the steps 328 to 338, the mechanical stress ceases.

Consequently, during a step 342, the protective membrane 126 returns to its initial idle position, thus ceasing to constrain the retaining tabs 128 which are displaced upwards.

During a step 344, the retaining tabs 128 come into contact with the hooks 125 of the percussion membrane 122.

During a step 346, the retaining tabs 128 exert, through the intermediary of the hooks 125, a retaining force driving the percussion membrane 122 towards its initial idle position.

It clearly appears that a mechanical stress detector such as the one described hereinabove can have a very reduced encumbrance, in particular a low thickness of only a few millimetres, thanks in particular to the use of the energy supplied by the mechanical stress that has to be detected.

It is therefore particularly adapted for its use in home automation where its low thickness allows it to be coupled to the floor on its lower surface (that of the bottom 112 of the case 106), by the intermediary of a seal, for example a silicone seal, or of a mat acting as an acoustical coupling with the support, i.e. the floor in this case. More preferably, as in the example described, the coupling surface is circular in such a way that the pulse detection signal generated following the crushing of the actuator 102 by the foot, propagates concentrically in the floor and at a characteristic frequency that can be easily identified using a selective filter centred on this frequency or via Fourier transform of the detected pulse signal.

The characteristic frequency can be customised by simply changing the dimensions of the resonating disc, in particular its diameter and/or its thickness. In this case, a series of detectors each having their own frequency which is slightly different from the others, can be distributed on determined places of passage in the flat, for example entrance doorsteps of the flat, of the kitchen, of the bathroom, of the bedroom, of the living room, etc.

Note that the detectors can be housed in mats arranged constantly in the areas of passage.

These detectors can be used to locate a person in a flat or to locate an intrusion in a facility or sensitive zone that has to be secured. The detectors thus operate more preferably with a system that detects the waves that they generate in the floor. The detection system more preferably includes at least one transducer receiver implementing a resonating element at the same frequency and including at least one piezoelectric ring on its periphery.

In the framework of this use on the floor, the mechanical stress is exerted by the foot of the person, and is therefore representative of his weight. So, encoding in the detection signal the information provided by the voltage Vm, makes it possible to obtain the weight of the person, of the animal or of the wheelchair walking/rolling on the mat. Note that the measurement can be repeated a certain number of times in the second that follows the impact by the striker according to the pulse energy available.

As indicated hereinabove, the percussion membrane 122 provides the energy required for the encoding of the identification information and for the modulation of the sound signal. Furthermore, the modulation device 144 generates the control signal via an amplitude modulation consisting, more preferably, in a frame comprising a bit, called a Start bit, of a duration of 1 ms at the central frequency, then 8 bits encoding the number of the detector, then 16 bits encoding the weight provided by the voltage Vm. Each bit lasts for example 1 millisecond. Thus, the detection signal consists, in the example described, of a series of oscillations at the frequency of resonance of the resonating disc 118 of a maximum amplitude if the bit to be transmitted is one or zero if the bit to be transmitted is zero. This detection signal propagates in the floor in order to be transmitted to a central monitoring unit, which itself is coupled to the floor via means of sound emission/reception.

Note that the amplitude modulation of the signal can consist of very short electrical pulses of the Dirac type that have to be repeated a certain number of times at regular intervals (with an amplitude of the all=1 or nothing=0 type) in order to constitute a predefined frame. In this case, the resonance frequency is that of the resonator under constraint, with the Dirac electrical pulse only revealing the frequency of the resonator under constraint.

Note moreover that the invention is not limited to the embodiments described hereinabove. Those skilled in the art can make various modifications to the embodiment described hereinabove, in light of the information which has just been disclosed.

In particular, the detection signal is not necessarily a sound signal. Indeed, the emission transducer could for example be a wireless communicating device, for example using radio frequencies such as ZIGBEE in order to transmit the information.

In the claims which follow, the terms used must not be interpreted as limiting the claims to the embodiment exposed in this description, but must be interpreted to include therein all of the equivalents that the claims aim to cover due to their formulation and of which the provision is within the scope of those skilled in the art and applying the general knowledge to the implementation of the information which has just been disclosed.

1-12. (canceled)

13. A mechanical stress detector comprising:
a control device configured to provide an electrical control signal in response to a mechanical stress;
an emission transducer configured to convert the electrical control signal into a detection signal;
a supply piezoelectric element, connected electrically to the control device and configured to provide, when mechanically excited, an electrical supply energy to the control device; and
a device for mechanically exciting the supply piezoelectric element using the mechanical stress,
wherein the emission transducer comprises an emission piezoelectric element to which is applied the control signal to supply the detection signal in a form of a seismic wave.

14. A detector according to claim 13, wherein the mechanical excitation device comprises a flexible element configured to sag in response to the mechanical stress, and, on a first range of sagging from an initial idle position to store up the potential energy, the first range of sagging comprising a drop in variation rate of the stored up potential energy.

15. A detector according to claim 14, wherein the flexible element is configured to, on a second range of sagging subsequent to the first range of sagging, restore the stored up potential energy.

16. A detector according to claim 14, wherein the mechanical excitation device further comprises a resonating element configured to be struck by the flexible element during its displacement, and wherein the supply piezoelectric element is fixed to the resonating element.

17. A detector according to claim 16, wherein the resonating element is a resonating disc arranged to be struck by the flexible element at its center, and wherein the supply piezoelectric element is a supply piezoelectric ring fixed along the periphery of a surface of the resonating disc.

18. A detector according to claim 13, further comprising a device for storing the electrical supply energy supplied by the supply piezoelectric element, the control device being supplied by the electrical supply energy stored in the storage device.

19. A detector according to claim 18, wherein the control device comprises an electrical signal source and a modulation device of the electrical signal of the source to generate the electrical control signal.

20. A detector according to claim 19, further comprising a source piezoelectric element configured to supply a source electrical energy, when excited, wherein the mechanical excitation device is configured to further excite the source piezoelectric element, and wherein the electrical signal source comprises a device for storing the source electrical energy supplied by the source piezoelectric element.

21. A detector according to claim 17, further comprising a source piezoelectric element configured to supply a source electrical energy, when excited, wherein the mechanical excitation device is configured to further excite the source piezoelectric element, and wherein the electrical signal source comprises a device for storing the source electrical energy supplied by the source piezoelectric element.

22. A detector according to claim 21, wherein the source piezoelectric element is a source piezoelectric ring fixed along a periphery of a surface of the resonating disc.

23. A detector according to claim 19, wherein the modulation device comprises a processing unit, supplied by the supply energy supplied by the supply piezoelectric element, configured to supply a digital control signal, and a switching device, controlled by the digital control signal, to connect the emission transducer selectively to the electrical signal source and to an electrical ground.

24. A detector according to claim 16, wherein the emission piezoelectric element is fixed on the resonating element.

25. A detector according to claim 20, wherein the emission piezoelectric element is fixed on the resonating element.

26. A detector according to claim 25, wherein the emission piezoelectric element is the source piezoelectric element.
